(19) United States
(12) Patent Application Publication
(10) Pub. No.: US 2006/0012680 A1
(43) Pub. Date: Jan. 19, 2006

(54) Drift-free video encoding and decoding method, and corresponding devices

(76) Inventor: Arnaud Bourge, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/531,010

(22) PCT Filed: Oct. 1, 2003
(86) PCT No.: PCT/IB03/04326

§ 371 Date: Apr. 12, 2005

(30) Foreign Application Priority Data
Oct. 16, 2002 (EP) 022905515

(51) Int. Cl. H04N 7/18

(52) U.S. Cl. 348/155

(57) ABSTRACT

Three-dimensional (3D) subband coding schemes use motion compensation in their temporal filtering stage. Unfortunately, this procedure introduces two drawbacks: (a) the MC being applied at the full resolution, a drift appears when decoding at a lower resolution, and (b) all the motion vectors estimated at full resolution are transmitted, which is a waste of bits. According to the invention, a low resolution sequence is first obtained by generating from the original input sequence of frames—by means of a wavelet decomposition—a sequence of low resolution frames and performing on them a motion compensated spatio-temporal analysis. Then, a motion compensated spatio-temporal analysis of each full resolution group of frames is performed, and the low frequency subbands of the decomposition are finally replaced, at each temporal decomposition level, by the corresponding spatio-temporal subbands of the generated low resolution sequence. The modified sequence thus obtained is finally coded. Thanks to this approach, a good behavior at low resolution is maintained (no more drift) while getting closer to the performance of a classic 3D subband codec at full resolution.

The present invention relates to an encoding method for the compression of an original video sequence divided into successive groups of frames (GOFs) and to a corresponding decoding method. It also relates to corresponding encoding and decoding devices.

The growth of the Internet and advances in multimedia technologies have enabled new applications and services for video compression. Many of them not only require coding efficiency but also enhanced functionality and flexibility in order to adapt to varying network conditions and terminal capabilities: scalability answers these needs. Current video compression standards, often based on a hybrid DCT (Discrete Cosine Transform) predictive structure, already include some scalability features. The hybrid structures are based on a predictive scheme where each frame is temporally predicted from a given reference frame (the prediction options being a forward prediction, for the P frames, or a bi-directional prediction, for the B frames) and the prediction error thus obtained is then spatially transformed (a two-dimensional DCT transform is used in the standard schemes) to get advantage of spatial redundancies. The scalability is achieved thanks to additional enhancement layers.

Alternatively, three-dimensional (3D) subband video coding techniques generate a single, embedded bitstream with full scalability. They rely on a spatio-temporal filtering that allows a reconstruction at any desired spatial resolution or frame rate. Such an approach is for example proposed in the document “Three-dimensional subband coding of video”, C. Podilchuk and al., IEEE Transactions on Image Processing, vol. 4, No. 2, February 1995, pp. 125-139, where a group of frames (GOF) is processed as a three-dimensional (2D+t, or 3D) structure and spatio-temporally filtered in order to compact the energy in the low frequencies (further studies included Motion Compensation in this scheme in order to improve the overall coding efficiency).

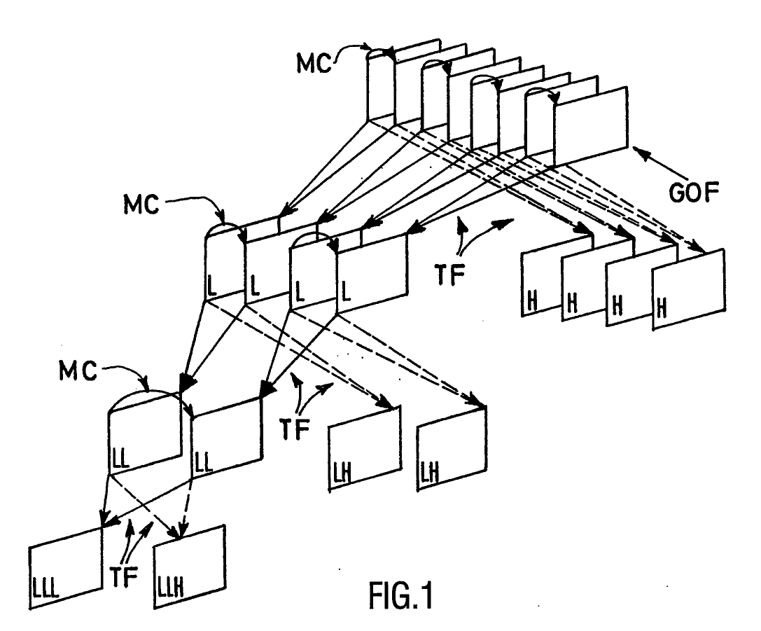

The 3D subband structure obtained with such an approach is depicted in FIG. 1, where the illustrated 3D wavelet decomposition with motion compensation is applied to a group of frames (GOF), and this current GOF is first motion-compensated (MC), in order to process sequences with large motion, and then temporally filtered (TF) using Haar wavelets (the dotted arrows correspond to a high-pass temporal filtering, while the other ones correspond to a low-pass temporal filtering). After the motion compensation operation and the temporal filtering operation, each temporal subband is spatially decomposed into a spatio-temporal subband, which finally leads to a 3D wavelet representation of the original GOF, three stages of decomposition being shown in the example of FIG. 1 (L and H=first stage; LL and LH=second stage; LLL and LLH=third stage). The well known SPIHT algorithm, extended from 2D to 3D, is then chosen in order to efficiently encode the final coefficient bit-planes with respect to the spatio-temporal decomposition structure.

As it is implemented, this 3D subband structure applies the motion-compensated (MC) spatio-temporal analysis at the full original resolution at the encoder side. Spatial scalability is achieved by getting rid of the highest spatial subbands of the decomposition. However, when motion compensation is used in the 3D analysis scheme, this method does not allow a perfect reconstruction of the video sequence at lower resolution, even at very high bit-rates: this phenomena, referred to as drift in the following description, lowers the visual quality of the scalable solution compared to a direct encoding at the targeted final display size. As explained in the document “Multiscale video compression using wavelet transform and motion compensation”, P. Y. Cheng and al., Proceedings of the International Conference on Image Processing (ICIP95), Vol. 1, 1995, pp. 606-609, said drift comes from the order of wavelet transform and motion compensation that is not interchangeable. When a spatial scalability is enabled at the decoder side, the highest spatial subbands of the decomposition performed at the encoder side are skipped, which allows the reconstruction, or synthesis, of a low-resolution version ad of the original frame A. For such a synthesis, the following operation is applied:

$$\begin{matrix}a = {DWT}_{L} ( L ) + MC [ {DWT}_{L} ( H ) ] \\ = {DWT}_{L} ( A ) + [ MC [ {DWT}_{L} ( H ) ] - {DWT}_{L} ( MC [ H ] ) ]\end{matrix} \qquad ( 1 )$$

where DWT_{L} Discrete Wavelet Transform, in the spatial domain) denotes the resolution downsample using the same wavelet filters as in the 3D analysis. In a perfect scalable solution, one wants to have:
a=DWT_{L}(A) (2)

The remaining part of the expression (1) therefore corresponds to the drift. It can be noticed that, if no MC is applied, the drift is removed. The same phenomena happens (except at the image borders) if a unique motion vector is applied to the frame. Yet, it is known that MC is unavoidable to achieve a good coding efficiency, and the likelihood of a unique global motion is small enough to eliminate this particular case in the following paragraphs.

Some authors, such as J. W. Woods and al in the document “A resolution and frame-rate scalable subband/wavelet video coder”, IEEE Transactions on Circuits and Systems for Video Technology, vol. 1, No. 9, September 2001, pp. 1035-1044, have already proposed technical solutions in order to get rid of this drift. However, in said document, the described scheme, in addition to being quite complex, implies the sending of an extra information (the drift correction necessary to correctly synthesize the upper resolution) in the bitstream, thus wasting some bits. The solution described in the document “Multiscale video compression . . .” previously cited avoids this bottleneck but works on a predictive scheme and is not transposable to the 3D subband codec.

It has then been proposed, in the European patent application No. 02290155.7 (PHFR020002) filed on Jan. 22^{nd}, 2002, a solution avoiding these drawbacks and according to which the video encoding method, used for the compression of an original video sequence divided into successive groups of frames (GOFs), comprises the steps of: (1) generating from the original video sequence, by means of a wavelet decomposition, a low resolution sequence including successive low resolution GOFs; (2) performing on said low resolution sequence a low resolution decomposition, by means of a motion compensated spatio-temporal analysis of each low resolution GOF; (3) generating from said low resolution decomposition a full resolution sequence, by means of an anchoring of the high frequency spatial subbands resulting from the wavelet decomposition to said low resolution decomposition; (4) coding said full resolution sequence and the motion vectors generated during the motion compensated spatio-temporal analysis, for generating an output coded bitstream.

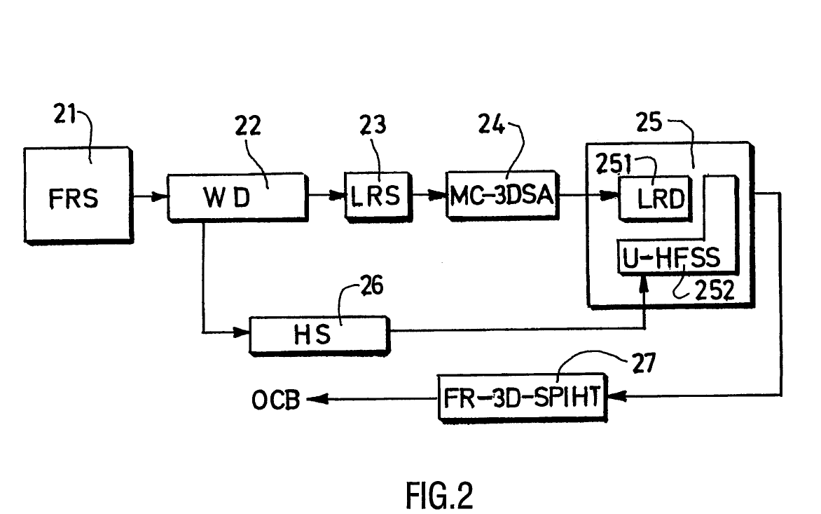

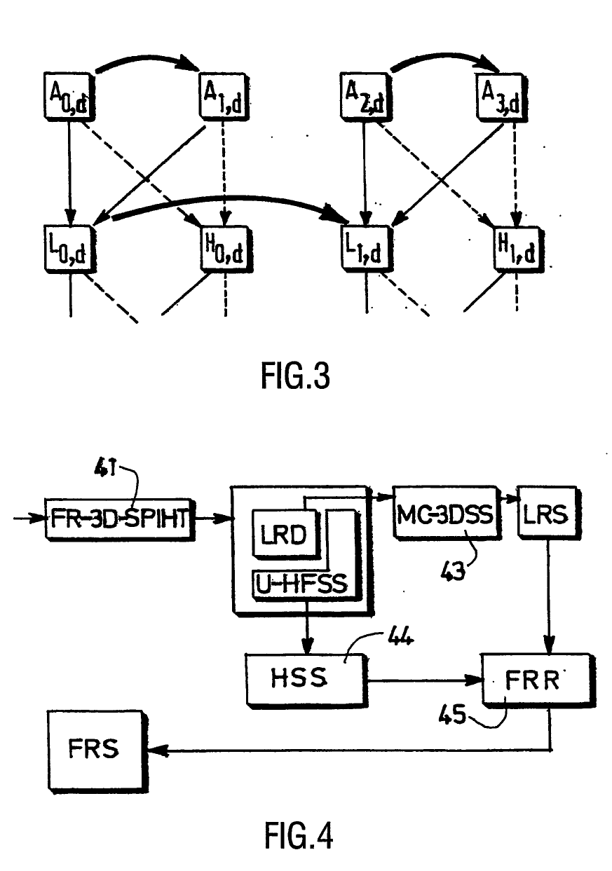

Said solution, in which the global structure of the decomposition tree in the 3DS analysis is preserved and no extra information is sent to correct the drift effect (only the decomposition/reconstruction mechanism is changed), is now recalled in a more detailed manner with reference to the coding scheme of FIG. 2 and to the motion-compensated temporal analysis at the lowest resolution, illustrated in FIG. 3.

Two main steps are provided: (a) a motion compensation step at the lowest resolution, (b) an encoding step of the high spatial subbands. First, in order to avoid drift at lower resolutions, Motion Compensation (MC) is applied at this level. Consequently the GOF at full resolution (21 in FIG. 2) is first downsized (this step is indicated by the reference d in FIG. 3, corresponding to the steps 22, 23 in FIG. 2) and the usual 3D subband MC-decomposition scheme is then applied to this downsized GOF instead of the full-size GOF, as depicted in FIG. 3 and illustrated by the step 24 in FIG. 2. In FIG. 3, the temporal subbands (L_{o,d}, H_{o,d}) and (L_{1,d}, H_{1,d}) are determined according to the well-known lifting scheme (H is first defined from A and B, and then L from A and H), and the dotted arrows correspond to the high-pass temporal filtering, the continuous ones to the low-pass temporal filtering, and the curved ones (between low frequency spatial subbands A of the frames of the sequence, referenced A_{o,d}, A_{1,d,}A_{2,d}, A_{3,d}, or between low frequency temporal subbands L, referenced L_{o,d} and L_{1,d}) to the motion compensation (it may be noticed that a side effect of this method is the reduction of the amount of motion vectors to be sent in the bitstream, which saves up some bits for texture coding). Before transmitting the subbands to a tree-based entropy coder (for instance, as shown in FIG. 2, to a 3D-SPIHT encoder 27, such as described for instance in the document “Low bit-rate scalable video coding with 3D set partitioning in hierarchical trees (3D-SPIHT)”, B. J. Kim and al. IEEE Transactions on Circuits and Systems for Video Technology, vol. 10, No. 8, December 2000, pp. 1374-1387), one puts (step 25) the high spatial subbands (26, in FIG. 2) that allow the reconstruction of the full resolution. The final tree structure looks very similar to that of a 3D subband codec such as the one described in the document “A fully scalable 3D subband video codec”, IEEE Conference on Image Processing (ICIP2001), vol. 2, pp. 1017-1020, Thessaloniki, Greece, Oct. 7-10, 2001, and so a tree-based entropy coder can be applied on it without any restriction. In the encoding scheme of FIG. 2, the references are the following (for a frame of the full resolution sequence 21):

FRS: full resolution sequence 21

WD: wavelet decomposition 22

LRS: low resolution sequence 23

MC-3DSA: motion-compensated 3D subband analysis 24

LRD: low resolution decomposition (251)

HS: high subbands 26

U-HFSS: union of the three high frequency spatial subbands of a frame (252)

FR-3D-SPIHT: full resolution 3D SPIHT 27

OCB: output coded bitstream.

The corresponding decoding scheme, depicted in FIG. 4, is symmetric to this encoder (in FIG. 4, the additional references are the following:

FR-3D-SPIHT: decoding step 41

MC-3DSS: motion compensated 3D subband synthesis 43

HSS: high subbands separation 44

FRR: fall resolution reconstruction 45 of the full resolution sequence).

To enable spatial scalability, the high frequency spatial subbands just have to be cut as in the usual version of the 3D subband codec, the decoding scheme of FIG. 4 showing how to naturally obtain the low resolution sequence.

Then, for coding the high spatial subbands, two main solutions are proposed, the first one without MC, and the second one with MC.

In the first solution, the high subbands simply correspond to the high frequency spatial subbands of the original (full resolution) frames of the GOF in the wavelet decomposition. Those subbands allow the reconstruction at full resolution at the decoding side. Indeed, the frames can be decoded at the low resolution. However, these frames correspond to the low spatial subband in the wavelet analysis of the original frames. Hence one has merely to put the low resolution frames and the corresponding high subbands together and apply a wavelet synthesis to obtain the full resolution frames, and thus to optimize the 3D-SPIHT encoder. In a MC scheme for a 3D subband encoder, the low temporal subbands always look like one of the original frames of the GOF. As a matter of fact:

$$L = \frac{1}{\sqrt{2}} [ A + MC ( B ) ] \qquad ( 3 )$$

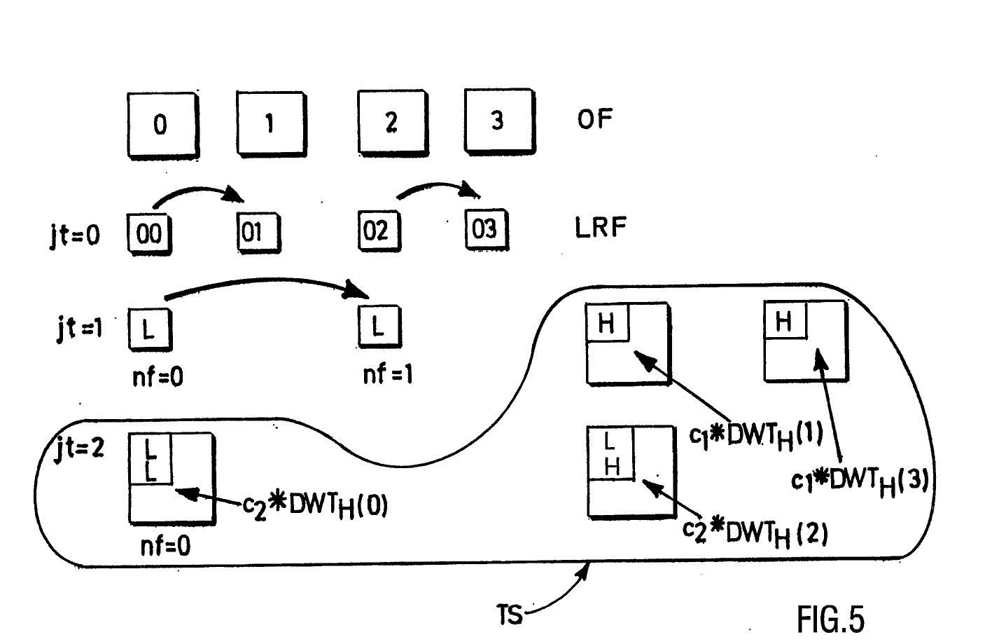

so L looks like A, Consequently, the high spatial subband of A should be placed with the low resolution decomposition corresponding to L. This approach (reordering of the high spatial subbands in the case of forward MC) is illustrated in FIG. 5, where jt indicates the temporal decomposition level (0 for the full-frame rate, jt_max for the lowest frame rate), nf is the subband index at the temporal level jt, DWT_{H} denotes the high frequency wavelet filter and the coefficients cⱼₜ are multiplication coefficients, and OF, LRF, TS respectively designate: the original frames referenced 0 to 3, the low resolution frames referenced 00 to 03, and the transmitted subbands.

In the second solution, as using MC in every subband does not allow a reconstruction with no drift, it is also possible to partially use MC to construct the high spatial subbands and still be able to reconstruct every resolution. Instead of directly using the high frequency spatial subbands of the wavelet decomposition, a wavelet decomposition is carried out on a prediction error obtained from the MC performed on the full resolution sequence and reusing for instance the motion vectors of the low resolution.

It is then an object of the invention to improve the previously described solution by keeping its good behavior at low resolution while getting closer to the performance of a classic 3D subband codec at full resolution.

To this end, the invention relates to a video encoding method for the compression of an original video sequence divided into successive groups of frames (GOFs), said method comprising the steps of: (1) generating from the full resolution frames of the original video sequence, by means of a wavelet decomposition, a sequence of low resolution frames organized in successive low resolution GOFs; (2) performing on each low resolution GOF of said sequence of low resolution frames a motion compensated spatio-temporal analysis, leading to a low resolution sequence; (3) performing a motion compensated spatio-temporal analysis of each full resolution GOF of the original video sequence; (4) replacing at each temporal decomposition level the low-frequency subbands of said decomposition by the corresponding spatio-temporal subbands of the low resolution sequence; (5) coding the modified sequence thus obtained and the motion vectors generated during the motion compensated spatio-temporal analysis of each full resolution GOF, for generating an output coded bitstream.

The invention also relates to a video decoding method dual of the above-defined video encoding method, and to the corresponding video encoding and decoding device.

The invention will now be described in a more detailed manner, with reference to the accompanying drawings in which:

FIG. 1 shows a 3D subband decomposition;

FIG. 2 depicts an embodiment of an encoding scheme according to a previous embodiment;

FIG. 3 illustrates a motion-compensated temporal analysis at the lowest resolution;

FIG. 4 depicts an embodiment of a decoding scheme corresponding to the encoding scheme of FIG. 2;

FIG. 5 illustrates the reordering of the high spatial subbands (for a forward motion compensation);

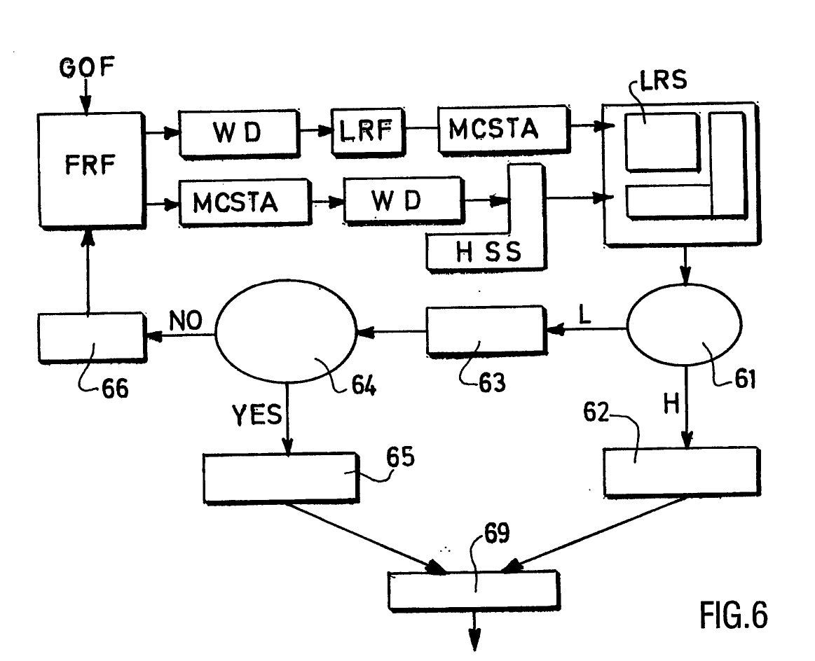

FIG. 6 illustrates the main steps of the encoding method according to the invention;

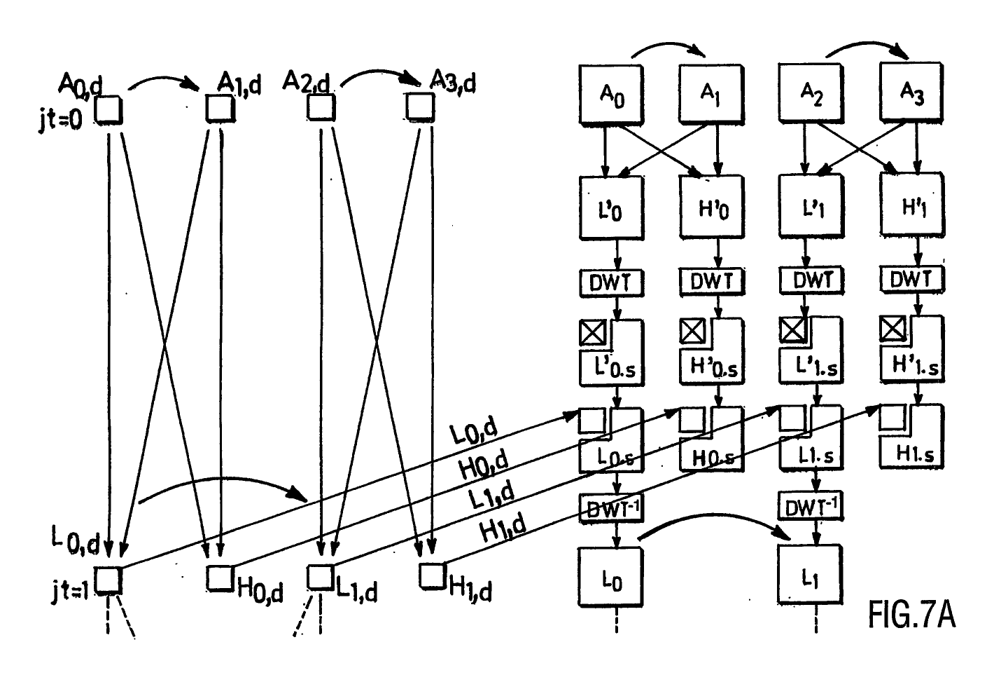

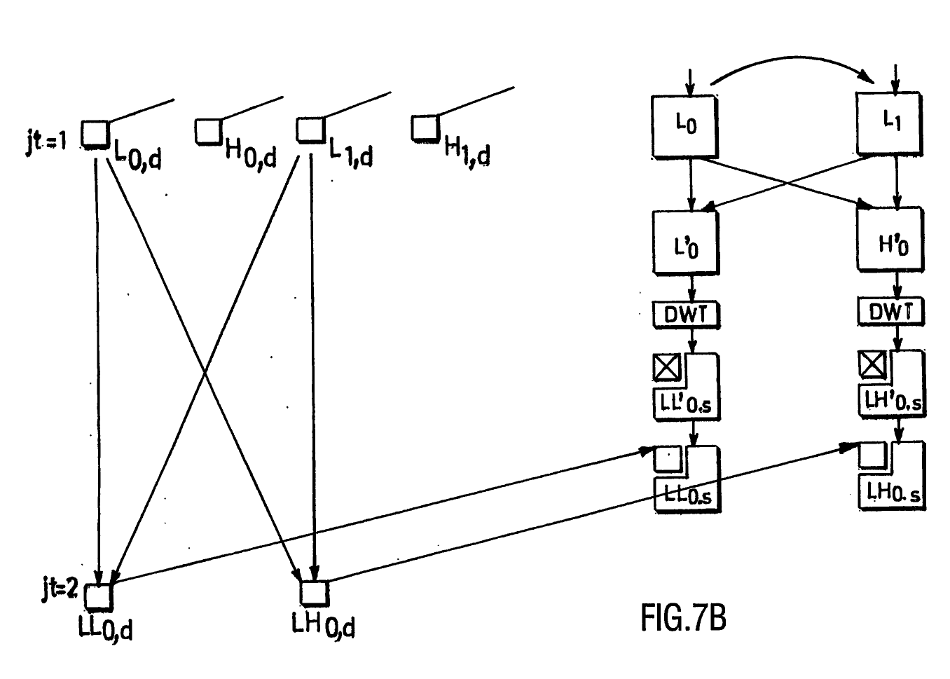

FIGS. 7A and 7B illustrate the corresponding motion compensated temporal filtering decomposition scheme;

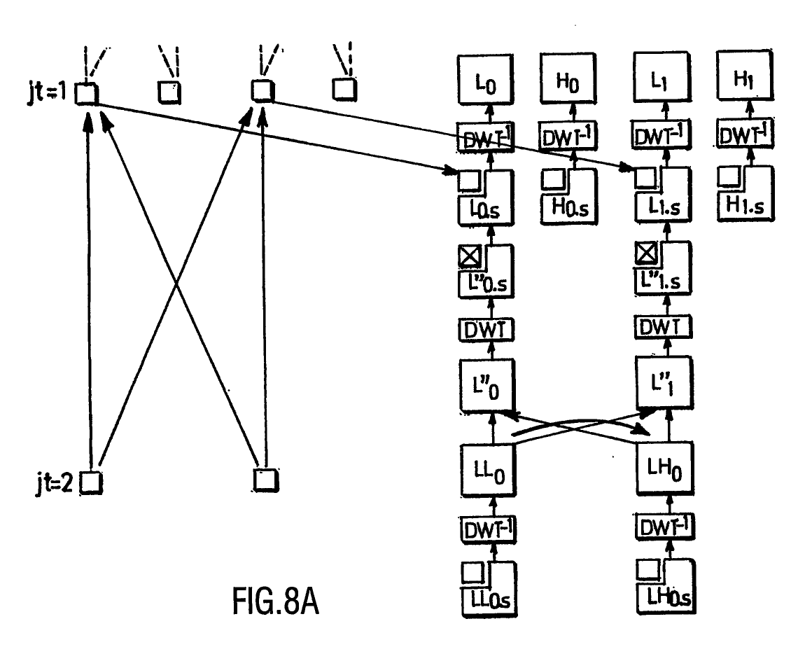

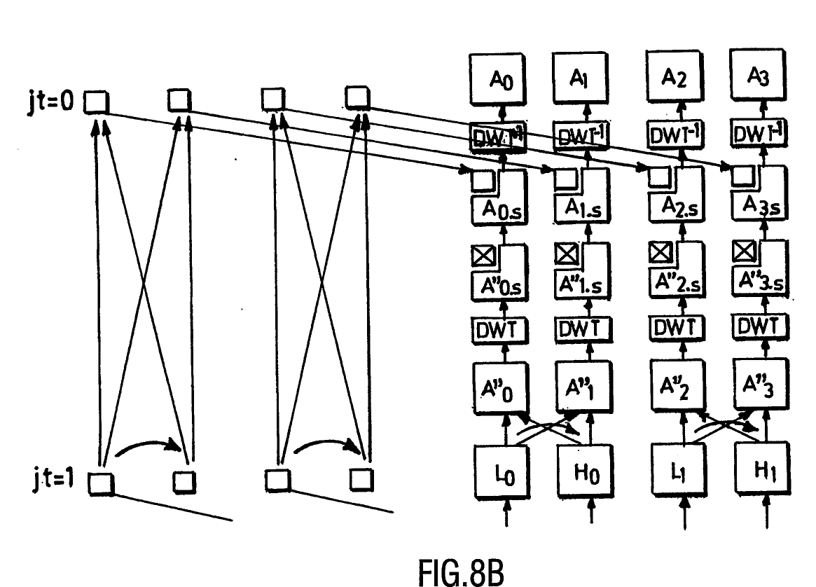

FIGS. 8A and 8B illustrate at the decoding side an implementation of a synthesis scheme corresponding to the encoding method of FIG. 5.

As for the previously described solution, the present invention is now explained with reference to its basic steps: (a) motion compensation at the lowest resolution (this first step, Motion Compensation (MC), is, in fact, strictly equivalent to the one described in the case of the previous solution: one first downsizes the GOF using the spatial wavelet filters, and the usual 3D subband MC-decomposition scheme is then applied to this downsized GOF), (b) encoding the high spatial subbands.

The main difference with said previous solution lies in the second step, the principle of which is to inject at each decomposition level the temporal subbands of the low spatial resolution analysis into those of the full-resolution one. It is thus possible to reconstruct the original frames at the decoder side while performing a real temporal filtering (and not just an intra coding or a predictive difference—as in the previous solution—for the high frequency spatial subbands).

The following equations explain the mechanism in a more detailed manner. As said above, the first temporal analysis is performed at low resolution, which may be expressed by the equations (4) and (5):
H_{d}=[B_{d}−MC_{down}(A_{d})]/\sqrt{2} (4)
L_{d}=[\sqrt{2}·A_{d}+MC_{down}⁻¹(H_{d})] (5)
with the following notations:

A=reference flame

B=current frame

DWT=discrete wavelet transform

A_{d}=low-frequency spatial subband of the DWT of frame A, i.e. a low-spatial resolution version of frame A

B_{d}=low-frequency spatial subband of the DWT of frame B, i.e a low-spatial resolution version of frame B

H=high-frequency temporal subband at the low spatial resolution

L=low-frequency temporal subband at the low spatial resolution

MC_{down}=motion compensation performed on low-resolution (i.e. sub-sampled) frames

MC⁻¹=inverse motion compensation (motion vectors computed to predict a frame B from a frame A are reversely used to predict the frame A from the frame B) The equations (6) to (9) then allow to define Lₛ and Hₛ:
H′=B−MC_{full}(A) (6)
L′=\sqrt{2}·A+MC_{full}⁻¹(H) (7)
Hₛ=H′ (8)
Lₛ=\sqrt{2}·l′ (9)
with:

Xₛ=union of the three high-frequency spatial subbands of the DWT of a given frame X (with X_{S}=H_{S} or L_{S})

MC_{full}=motion compensation performed on full-resolution frames

L′ and H′=respectively the low-frequency and high-frequency temporal subbands in a conventional 3D subband scheme
H=DWT⁻¹[H_{d}∪Hₛ]
L=DWT⁻¹[L_{d}∪Lₛ]

Once all the low-frequency and high-frequency temporal subbands have been generated at a given temporal level jt, both at low and full spatial resolutions, the low-frequency temporal subbands L are further decomposed to achieve the next temporal level jt+1.

This is repeated at each step of the temporal decomposition, leading finally to a structure of the temporal decomposition which is very similar to that of a classic 3D subband encoder. The low frequency temporal subband of the last level and the high frequency temporal subbands of all levels are then spatially decomposed through wavelet filters and encoded to form the bitstream.

The described invention keeps the good behavior of the previous solution at low resolution while getting closer to the performance of a classic 3D subband codec at full resolution (the global structure of the decomposition tree in the 3D subband analysis is preserved and no extra information is sent to correct the drift effect; only the decomposition/reconstruction mechanism is changed). The main upgrade comes from the new approach to generate the high-frequency spatial subbands, that brings more coherence to the decomposition tree and therefore improves the coding efficiency of the system.

At the decoder, all the previous equations can be reverted to allow a good reconstruction. Only a ˆ is added to every subband in order to indicate that decoding is now concerned and that some information might have been lost. First a classic 3D subband synthesis at low resolution allows to give back the low spatial resolution subbands A_{d} and B_{d} from L_{d} and H_{d}:

$$\begin{matrix}{\hat{A}}_{d} = \frac{1}{\sqrt{2}} [ {\hat{L}}_{d} - {MC}_{down}^{- 1} ( {\hat{H}}_{d} ) ] & ( 10 ) \\ {\hat{B}}_{d} = {MC}_{down} ( {\hat{A}}_{d} ) + \sqrt{2} * {\hat{H}}_{d} & ( 11 )\end{matrix}$$

It is also easy to get Aₛ by synthesizing H and by reverting the equation (7). The process is explained by the equations (12) to (15):

$$\begin{matrix}\hat{H} = {DWT}^{- 1} [ {\hat{H}}_{d} ⋃ {\hat{H}}_{s} ] & ( 12 ) \\ \hat{L} = {DWT}^{- 1} [ {\hat{L}}_{d} ⋃ {\hat{L}}_{s} ] & ( 13 ) \\ {\hat{A}}_{s}^{n} = \frac{1}{\sqrt{2}} [ \hat{L} - {MC}_{full}^{- 1} ( \hat{H} ) ] & ( 14 ) \\ {\hat{A}}_{s} = {A}_{s}^{n} & ( 15 )\end{matrix}$$

Then Â is simply reconstructed from Â_{d} and Âₛ. Consequently one can get Bₛ and finally synthesize B. This is summarized by the system of equations (16) to (19):
Â=DWT⁻¹[Â_{d}∪Âₛ] (16)
\hat{B}ₛⁿ=MC_{full}(Â)+Ĥ (17)
\hat{B}ₛ=\hat{B}ⁿₛ (18)
\hat{B}=DWT⁻¹[\hat{B}_{d}∪\hat{B}ₛ] (19)

These operations are repeated until the very first temporal level, i.e. until the GOF is fully decoded. It can clearly be seen that this scheme generates no drift since perfect reconstruction is achieved as soon as L and H are completely transmitted in the bit-stream (it can also be noted that the full spatial resolution synthesis is now intimately linked with the low resolution one at each temporal level, which was not the case in the previous solution).

The encoding principle defined above is now described in a more detailed manner, with reference to FIG. 6, that illustrates the main steps of the encoding method, and FIG. 7 (comprising in fact two Figures: FIG. 7A and FIG. 7B), that illustrates in a more detailed manner the corresponding motion compensated temporal filtering scheme.

In the encoding scheme of FIG. 6, the original group of frames GOF (this current GOF comprises full resolution frames FRF) is first used for generating, by means of a wavelet decomposition WD, low resolution frames LRF on which a motion compensated spatio-temporal analysis MCSTA is then performed. A low resolution sequence is thus obtained. The original full resolution frames (i.e. each full resolution GOF) are also used for performing a motion compensated spatio-temporal analysis (the corresponding successive steps MCSTA and WD correspond to a: “MC-temporal analysis” and a “wavelet decomposition”) for generating high spatial subbands HSS.

After these two parallel sets of steps performed on the full resolution frames, the low frequency subbands of the decomposition thus obtained are iteratively replaced, at each temporal decomposition level, by the corresponding spatio-temporal subbands of the low resolution sequence LRS, according to the following operations: (a) first, a storing operation 62, for storing the high frequency spatio-temporal subbands of the decomposition in view of the final encoding step 69; (b) then a wavelet synthesis 63, performed from the low frequency spatio-temporal subbands of said decomposition (a test 61 “L or H temporal subband” has allowed to separate said low frequency and high frequency spatio-temporal subbands); (c) then a test 64 concerning the rank of the temporal decomposition level, for storing (65) the low frequency spatio-temporal subbands of the decomposition if said level is the last one, the two parallel sets of steps being on the contrary further carried out for the next temporal level (66) if said level is not the last one.

More detailed representations of the whole decomposition scheme (at the enconding side) and the corresponding motion-compensated synthesis scheme (at the decoding side) can be seen in FIG. 7 and FIG. 8 (also comprising two Figures: FIG. 8A and FIG. 8B) respectively. This example of a spatio-temporal decomposition according to the invention is related to a GOF of only four frames A0 to A3 (for the sake of simplicity), with a forward motion compensation and two decomposition levels. The high and low frequency (H′₀, H′₁ and L′₀, L′₁ respectively) temporal subbands are computed from the original frames by using the so-called lifting scheme, described for instance in the document “Factoring wavelet transforms into lifting steps”, I. Daubechies and W. Sweldens, Bell Laboratories technical report, Lucent Technologies, 1996. The notations DWT and DWT⁻¹ respectively designate the wavelet decomposition and the wavelet synthesis. The right side of FIG. 7 illustrates successively the first spatio-temporal decomposition level, the inverse synthesis applied to the low frequency spatio-temporal subbands of the decomposition and the second spatio-temporal decomposition level (performed after the replacement of the low frequency subbands of the decomposition by the corresponding spatio-temporal subbands of the low resolution sequence, said replacement being indicated by the arrows coming from the left side of FIG. 7).

The video encoding method and device according to the invention have been described above in a detailed manner, but it is clear that the invention also relates to a corresponding video decoding method, that comprises successive steps dual of the steps performed when implementing said video encoding method, and to a corresponding video decoding device, that comprises successive means dual of the means provided in said video encoding device.

1. A video encoding method for the compression of an original video sequence divided into successive groups of frames (GOFs), said method comprising the steps of:
(1) generating from the fill resolution frames of the original video sequence, by means of a wavelet decomposition, a sequence of low resolution frames organized in successive low resolution GOFs;
(2) performing on each low resolution GOF of said sequence of low resolution frames a motion compensated spatio-temporal analysis, leading to a low resolution sequence;
(3) performing a motion compensated spatio-temporal analysis of each full resolution GOF of the original video sequence;
(4) replacing at each temporal decomposition level the low-frequency subbands of said decomposition by the corresponding spatio-temporal subbands of the low resolution sequence;
(5) coding the modified sequence thus obtained and the motion vectors generated during the motion compensated spatio-temporal analysis of each fill resolution GOF, for generating an output coded bitstream.

2. A video encoding device for the compression of an original video sequence divided into successive groups of frames (GOFs), said device comprising:
(1) means for generating from the full resolution frames of the original video sequence and by means of a wavelet decomposition, a sequence of low resolution frames organized in successive low resolution GOFs;
(2) means for performing on each low resolution GOF of said sequence of low resolution frames a motion compensated spatio-temporal analysis, leading to a low resolution sequence;
(3) means for performing a motion compensated spatio-temporal analysis of each full resolution GOF of the original video sequence;
(4) means for replacing at each temporal decomposition level the low-frequency subbands of said decomposition by the corresponding spatio-temporal subbands of the low resolution sequence;
(5) means for coding the modified sequence thus obtained and the motion vectors generated during the motion compensated spatio-temporal analysis of each full resolution GOF, for generating an output coded bitstream.

3. A video decoding method, provided for decoding a coded bitstream corresponding to a video sequence coded by means of a video encoding method comprising, for the compression of said original video sequence, the steps of:
(1) generating from the full resolution frames of the original video sequence, by means of a wavelet decomposition, a sequence of low resolution frames organized in successive low resolution GOFs;
(2) performing on each low resolution GOF of said sequence of low resolution frames a motion compensated spatio-temporal analysis, leading to a low resolution sequence;
(3) performing a motion compensated spatio-temporal analysis of each full resolution GOF of the original video sequence;
(4) replacing at each temporal decomposition level the low-frequency subbands of said decomposition by the corresponding spatio-temporal subbands of the low resolution sequence;
(5) coding the modified sequence thus obtained and the motion vectors generated during the motion compensated spatio-temporal analysis, of each full resolution GOF, for generating an output coded bitstream;
said video decoding method comprising successive steps that are dual of the steps performed according to the video encoding method of claim 1.

4. A video decoding device, provided for decoding a coded bitstream corresponding to a video sequence coded by means of a video encoding device comprising, for the compression of said original video sequence:
(1) means for generating sequence from the full resolution frames of the original video sequence and by means of a wavelet decomposition, a sequence of low resolution frames organized in successive low resolution GOFs;
(2) means for performing on each low resolution GOF of said sequence of low resolution frames a motion compensated spatio-temporal analysis, leading to a low resolution sequence;
(3) means for performing a motion compensated spatio-temporal analysis of each full resolution GOF of the original video sequence;
(4) means for replacing at each temporal decomposition level the low-frequency subbands of said decomposition by the corresponding spatio-temporal subbands of the low resolution sequence;
(5) means for coding the modified sequence thus obtained and the motion vectors generated during the motion compensated spatio-temporal analysis, of each full resolution GOF, for generating an output coded bitstream;
said video decoding device comprising successive means that are dual of the means provided in the video encoding device according to claim 2.
